(19) United States
(12) Patent Application Publication
(10) Pub. No.: US 2002/0138518 A1
(43) Pub. Date: Sep. 26, 2002

(54) Method and system for code processing of document data

(75) Inventors: Arei Kobayashi, Saitama (JP); Satoru Takagi, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 10/025,610

(22) Filed: Dec. 26, 2001

(30) Foreign Application Priority Data
Dec. 27, 2000 (JP) 397002/2000

(51) Int. Cl. G06F 15/00

(52) U.S. Cl. 707/513

(57) ABSTRACT

A method for code processing of document data comprises steps of encoding a document data written in a description language of an extensible text format to a code data, based on a translation table written in a description language of an extensible text format, and processing the code data as the document data based on the translation table. The translation table defines link information of other translation tables. Also, the translation table defines a code length and a code assigned to items of the link information, an element name, an element value of the element name, an attribute name designated in the element name, an attribute value of the attribute name. Furthermore, the translation table defines a code length and a code assigned for designate parentage structure between one element name and other element name.

### FIELD OF THE INVENTION

The present invention relates to a method and system for code processing of document data.

### DESCRIPTION OF THE RELATED ART

Conventionally, there is a method for encoding and decoding document data to reduce an amount of data to be transmitted. In order to achieve this method, a sender and a receiver respectively need to have the same translation tables. Each translation table stores a one-to-one correspondence data between description languages and codes. At the sender side, document data to be transmitted will be encoded into code data using the translation table, and at the receiver side, the code data received will be decoded into the document data using the translation table.

Such encoding and decoding method may be effective in particular in the Internet. For example, a Web server may encode document data written in a markup language of text format such as HTML (HyperText Markup Language) into code data, and send the encoded data to clients. Each client may decode the received code data to the document data, and provide the decoded document data to a browser. Since the encoded data of the document data are transmitted, an amount of data transmitted can be reduced.

Encoding of the document data is also effective from the viewpoint of security in the Internet. This is because any client with no translation table is impossible to decode the code data.

FIG. 1 illustrates a conventional encoding and decoding method of the document data. As shown in the figure, at a sending side, a document data 12 of HTML format is encoded by an encoding unit 10 to a code data based on a translation table 11. At a receiving side, the received code data is decoded by a decoding unit 20 to a document data 22 of HTML format based on a translation table 21. A parser 23 analyzes logical structure of elements in the document data 22, and then displays the document data 22 on a browser 24.

According to this conventional method, it is necessary that the translation table 11 used at encoding is the same as the translation table 21 used at decoding.

Recent document data sent from the Web server include not only data of HTML format but also data of markup language of extensible text format such as XML (Extensible Markup Language) or SGML (Standard Generalized Markup Language) for example. The HTML format only specifies an informational viewing, whereas the markup language can specifies an informational viewing and also specify a logical structure of elements. Thus, in case that the text format of the document data is extended, according to the conventional encoding and decoding method shown in FIG. 1, it is necessary to extend both the translation tables 11 and 21. Also, since the markup language specifies the logical structure of elements, the code data has to be decoded to the document data and the logical structure of elements needs to be analyzed and processed by the parser 23.

### SUMMARY OF THE INVENTION

It is therefore an object of the present invention to provide a method and system for code processing of document data, whereby document data written by the description language of an extensible text format can be encoded, and document processing can be performed without decoding code data to document data.

According to the present invention, particularly, a method for code processing of document data comprising the steps of: encoding a document data written in a description language of an extensible text format to a code data, based on a translation table written in a description language of an extensible text format; and processing the code data as the document data based on the translation table, the translation table defining link information of other translation tables, defining a code length and a code assigned to items of the link information, an element name, an element value of the element name, an attribute name designated in the element name, an attribute value of the attribute name, and defining a code length and a code assigned for designate parentage structure between one element name and other element name.

Thereby, since the translation table itself is extensible, it can correspond to an extensible document data. Moreover, since the logical structure of elements can be included in code data by the translation table, a document processing can be performed directly without decoding to the document data and without parsing. According to the present invention, it is effective that a processing load is small for the receiver that has only a low performance, for example, a portable telephone.

It is preferred that the items defined in the translation table used in the processing step are a subset of the items defined in the translation table used in the encoding step.

For example, it is assumed that one receiver has only one part with the translation table, and other receiver has only other part with the translation table. The sender sends the code data that encoded a document data, to a plurality of the receiver. Thereby, one receiver can display only one part in the document data, and other receiver can display only other part in the document data. Although the code data to be sent is the same, the viewing of document processing differs as for a difference in the translation table used by the receiver. Such function is effective in the viewpoint of a security.

It is preferred that the encoding step encodes only the items that are defined in the translation table.

Thereby, it can avoid that since a part of document data cannot be encoded, the whole document data cannot be encoded.

It is preferred that the encoding step includes adding of an occupancy data which indicates a length occupied by the item to a code indicating the item, and wherein the processing step decodes from the code data of a position that skips the occupancy data length of the code, in case that the code not defined in the translation table exists in the code data, without processing the code.

Thereby, a part that is not able to decode in the code data can be skipped.

According to the present invention, a system for code processing of a document data comprising: server for sending a document data written in a description language of an extensible text format; encoding server for encoding the received document data to a code data based on a translation table, and sending the code data; and client for processing of the code data as the document data based on the translation table, the translation table being written in a description language of an extensible text format, defining a link information of other translation tables, defining a code length and a code assigned to items of the link information, an element name, an element value of the element name, an attribute name designated in the element name, an attribute value of the attribute name, and defining a code length and a code assigned to designate parentage structure between one element name and other element name.

Thereby, an existing server can be used.

It is preferred that the items defined in the translation table used by the client are a subset of the items defined in the translation table used in the encoding server.

It is preferred that the encoding server encodes only the items defined in the translation table.

It is preferred that the encoding server adds an occupancy data which indicates a length occupied by the item to a code indicating the item, and wherein the client decodes from the code data of a position that skips the occupancy data length, in case that the code not defined in the translation table exists in the code data.

It is possible that a description language of an extensible text format is encoded by this translation table.

Further objects and advantages of the present invention will be apparent from the following description of the preferred embodiments of the invention as illustrated in the accompanying drawings.

### BRIEF DESCRIPTION OF THE DRAWINGS

FIG. 1, already described, shows a block diagram schematically illustrating a conventional basic encoding and decoding method;

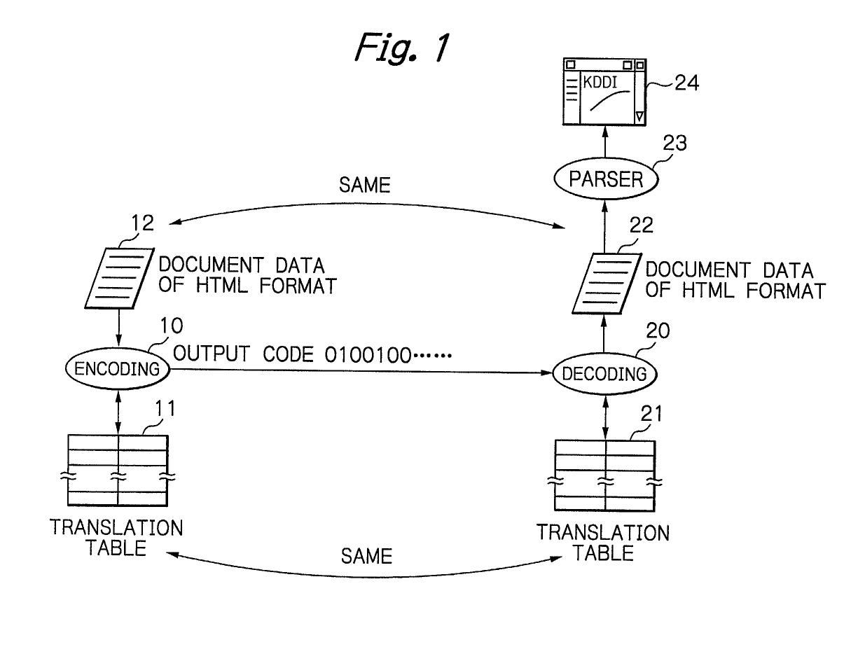

FIG. 2 shows a block diagram schematically illustrating an encoding and code processing method according to the present invention;

FIG. 3 illustrates a sample of document data of XML format;

FIG. 4 illustrates an example of code data for the document data shown in FIG. 3;

FIG. 5a illustrates a translation table, particularly of a header part, used for encoding the document data shown in FIG. 3 to the code data shown in FIG. 4;

FIG. 5b illustrates a translation table, particularly of a root part, used for encoding the document data shown in FIG. 3 to the code data shown in FIG. 4;

FIG. 5c illustrates a translation table, particularly of a first child element, used for encoding the document data shown in FIG. 3 to the code data shown in FIG. 4;

FIG. 5d illustrates a translation table, particularly of a second child element, used for encoding the document data shown in FIG. 3 to the code data shown in FIG. 4;

FIG. 6 illustrates a translation table containing link information with other translation tables;

FIG. 7 illustrates a code data additionally including an occupancy data that indicates a length occupied by each element;

FIG. 8 shows a block diagram illustrating a system configuration of a first embodiment according to the present invention;

FIG. 9 shows a block diagram illustrating a system configuration of a second embodiment according to the present invention; and

FIG. 10 shows a flowchart illustrating a document processing according to the present invention.

### DESCRIPTION OF PREFERRED EMBODIMENTS

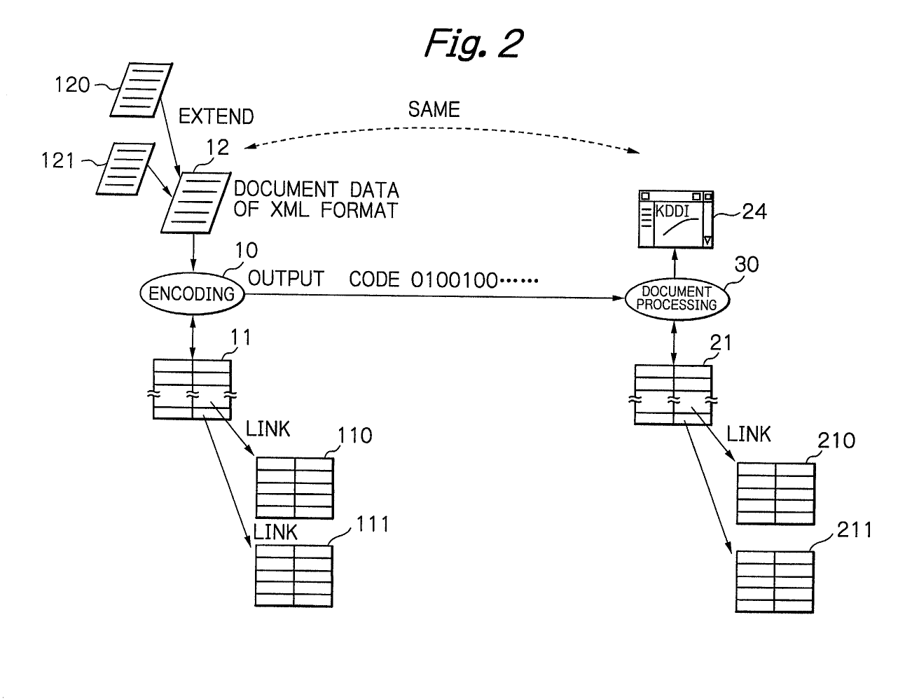

FIG. 2 schematically illustrates an encoding and code processing method according to the present invention. As shown in the figure, at a sending side, a document data 12 is extended by a plurality of document data 120 and 121. Also, a translation table 11 defines link information with respect to a plurality of translation tables 110 and 111 corresponding to the extended document data. Thereby, the document data 12 of XML format is encoded by an encoding unit 10 to a code data based on the translation table 11.

At a receiving side, the received code data is processed directly based on a translation table 21 by a document-processing unit 30, and the processed document is displayed on a browser 24.

According to the present invention, since the code data contains a logical structure of elements, it is not necessary to decode the received code data into a document data and also to further analyze the logical structure at the parser 23 as did in the conventional method.

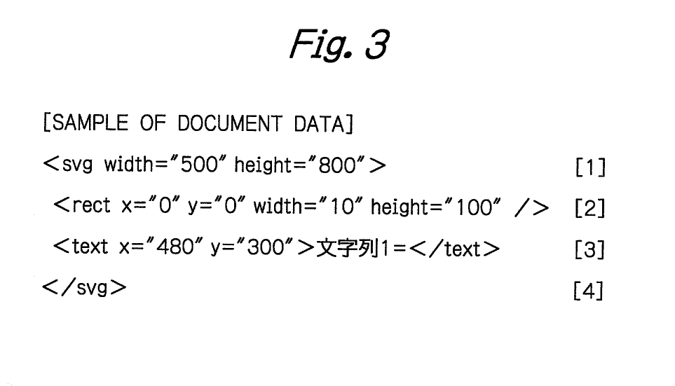

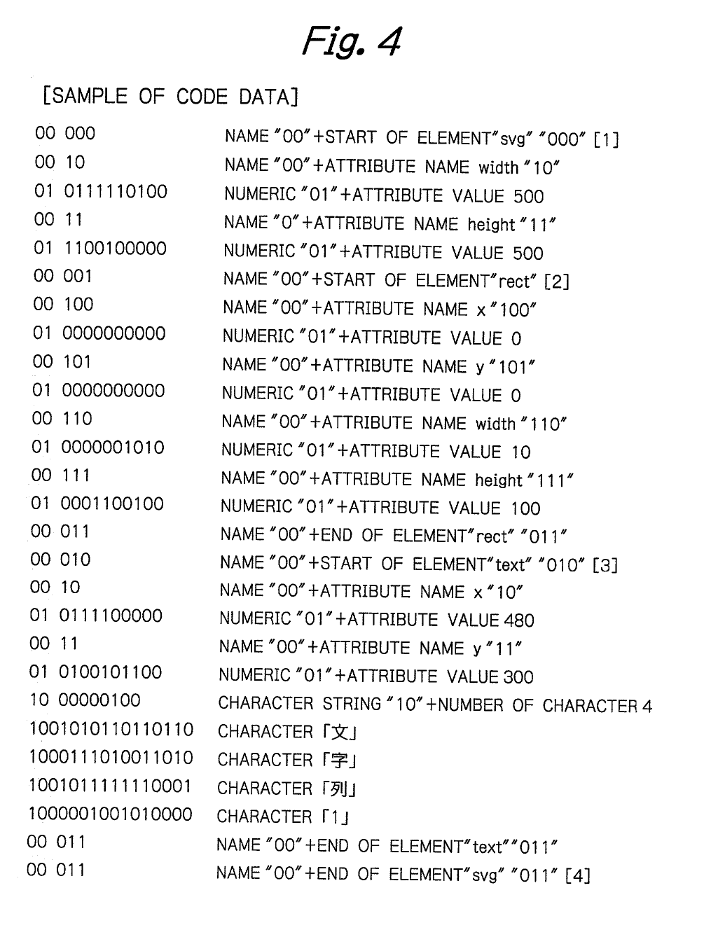

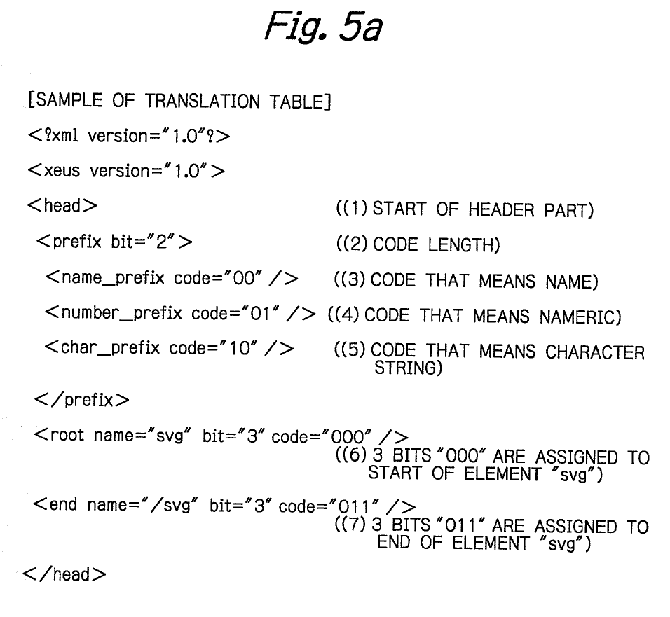

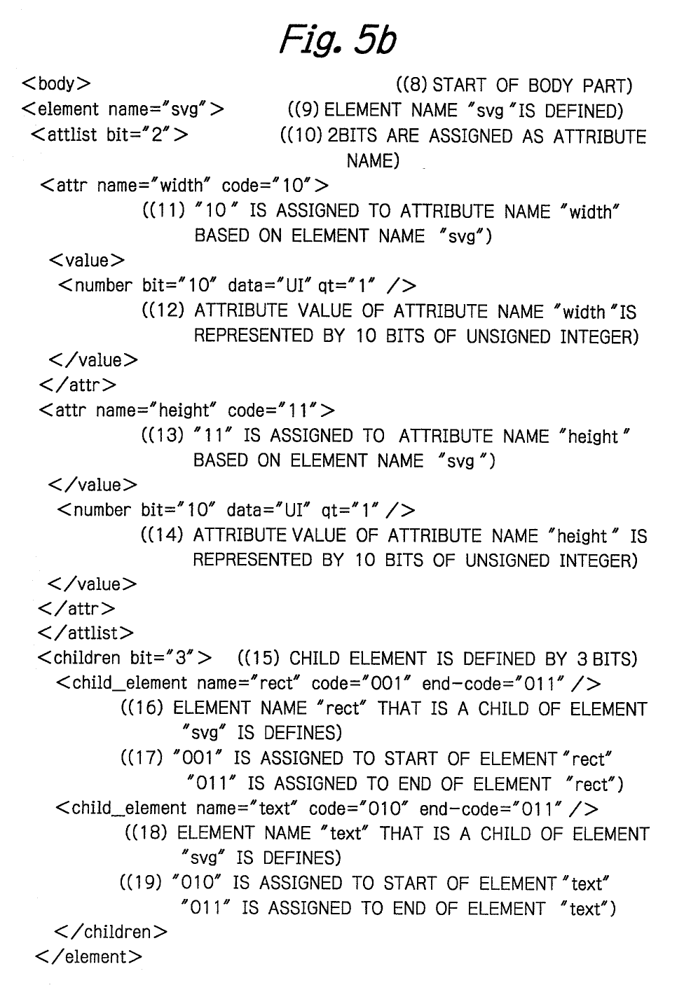

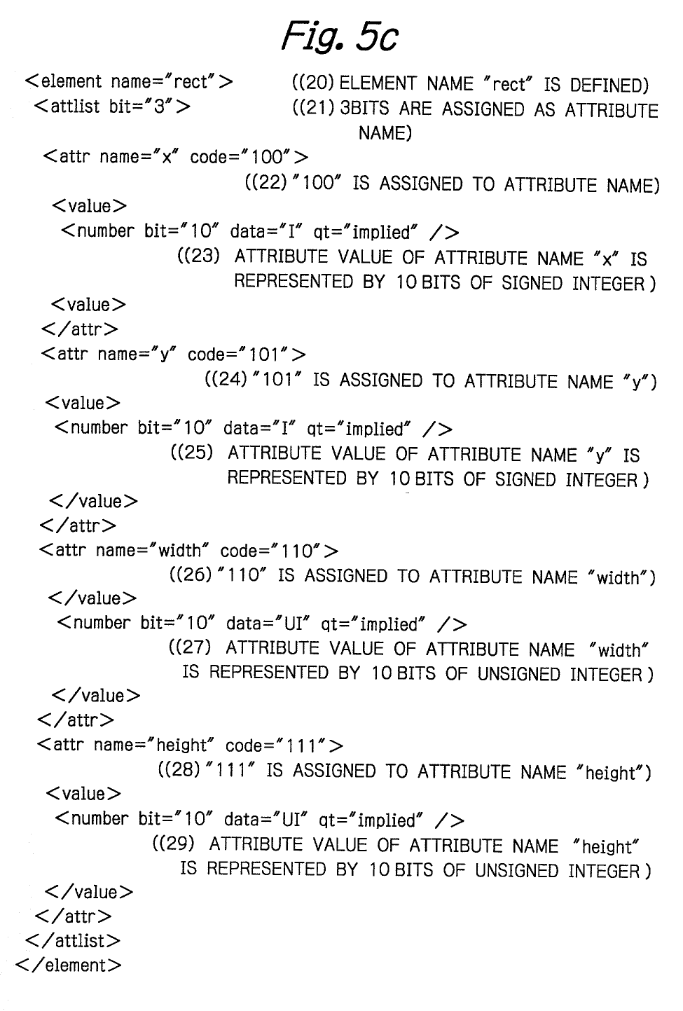

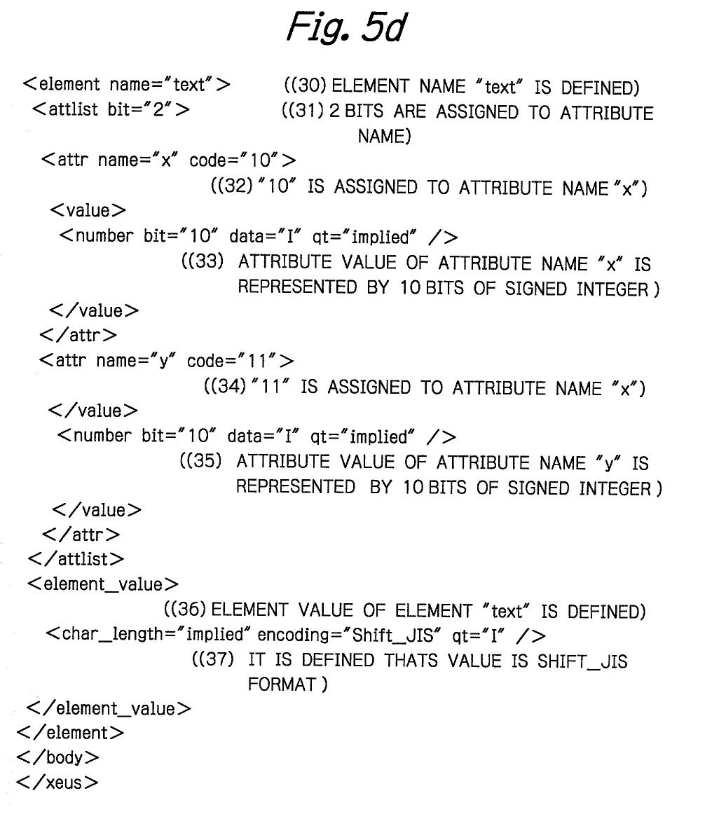

FIG. 3 illustrates a sample of a document data of XML format, FIG. 4 illustrates a sample of a code data for the document data shown in FIG. 3, and FIGS. 5a-5d illustrate various elements of a translation table for encoding the document data shown in FIG. 3 into the code data shown in FIG. 4. Hereinafter, contents of the translation table shown in FIGS. 5a-5d will be described with reference to FIGS. 3 and 4.

The translation table is written by XML format and is separated into a head part <head> (1) shown in FIG. 5a and a body part <body> (8) shown in FIGS. 5b-5d. In the head part, a prefix is written. Whereas, in the body part, a logical structure of the document data and a translation code are written.

As shown in FIG. 5a, in the head part, two bits are assigned for a code length (2) of the prefix. A code “00” (3) is assigned for the prefix of an element name and an attribute name. If an element value and an attribute value are described in a numeric value, a code “01” (4) is assigned for them. Whereas, if the element value and the attribute value are described in a character string, a code “10” (5) is assigned for them.

Since the document data shown in FIG. 3 defines an element name “svg”, a code “000” (6) is assigned for a start of the element name “svg”, and a code “011” (7) is assigned for an end of the element name “svg” as shown in FIG. 5a.

As shown in FIG. 5b, first, the element name “svg” is defined (9). A code length of two bits is assigned for the attribute name based on the element name “svg” (10). A code “10” is assigned for an attribute name “width” (11), and a code “11” for an attribute name “height” (13). Moreover, an attribute value of the attribute name “width” is represented by ten bits of unsigned integer (12), and the attribute value of the attribute name “height” is represented by ten bits of unsigned integer (14).

Next, a child element of the element name “svg” is defined with three bits of code lengths (15). An element name “rect” is defined as a child element of the element name “svg” (16). A code “001” is assigned for a start of element name “rect”, and a code “011” assigned for a end of element name “rect” (17). Moreover, an element name “text” is defined as a child element of the element name “svg” (18). A code “010” is assigned for a start of element name “text”, and a code “011” for a end of the element name “text” (19).

As shown in FIG. 5c, the element name “rect” is defined (20). Three bits in the code length is assigned for the attribute name attributed to the element name “rect” (21). A code “100” is assigned for an attribute name “x” (22) and an attribute value of the attribute name “x” is represented by ten bits of signed integers (23). A code “101” is assigned for an attribute name “y” (24), and the attribute value of the attribute name “y” is represented by ten bits of signed integers (25). Moreover, a code “110” is assigned for the attribute name “width” (26), and the attribute value of the attribute name “width” is represented by ten bits of unsigned integer (27). Finally, a code “111” is assigned for an attribute name “height” (28), and an attribute value of the attribute name “width” is represented by ten bits of unsigned integer (29).

As shown in FIG. 5d, the element name “text” is defined (30). Moreover, two bits in the code length are assigned for an attribute name based on the element name “text” (31). A code “10” is assigned for the attribute name “x” (32), and an attribute value of the attribute name “x” is represented by ten bits of signed integers (33). A code “11” is assigned for an attribute name “y” (34), and an attribute value of the attribute name “y” is represented by ten bits of signed integers (35).

Next, an element value of the element “text” is defined (36). It is defined that an element value is a Shift-JIS (Shift-Japanese Industrial Standards) format (37).

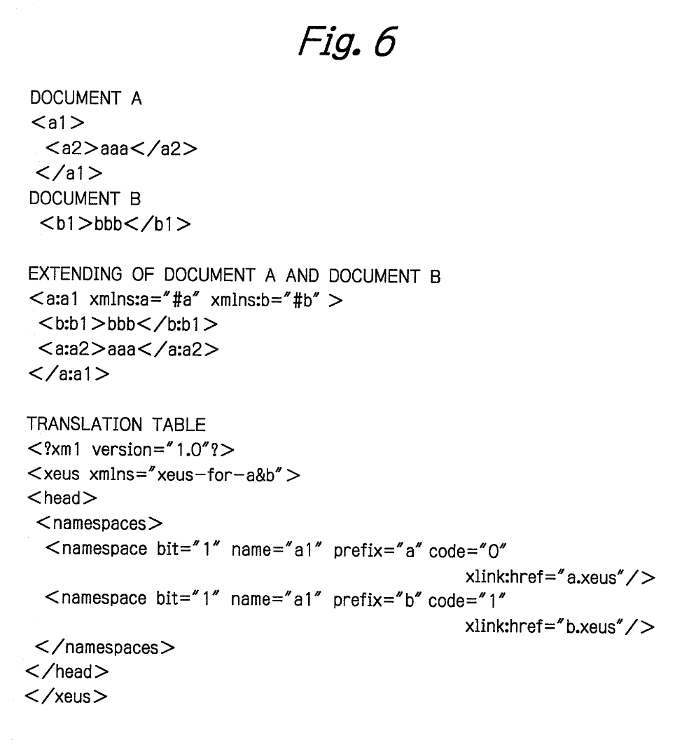

FIG. 6 illustrates a translation table containing link information of a plurality of other translation tables.

A target description language according to the present invention is of an extensible text format. Therefore, when the document data is extended, the translation table needs to be extended similarly. As shown in FIG. 6, the link information of a plurality of translation tables is defined only in the header part, and thus the translation table itself is not necessary to be re-created. The header part defines meta-information for extending a plurality of the translation tables. The meta-information means a code and a code length of a prefix code, a specification of an element, a specification of a name space, and link information to the translation table.

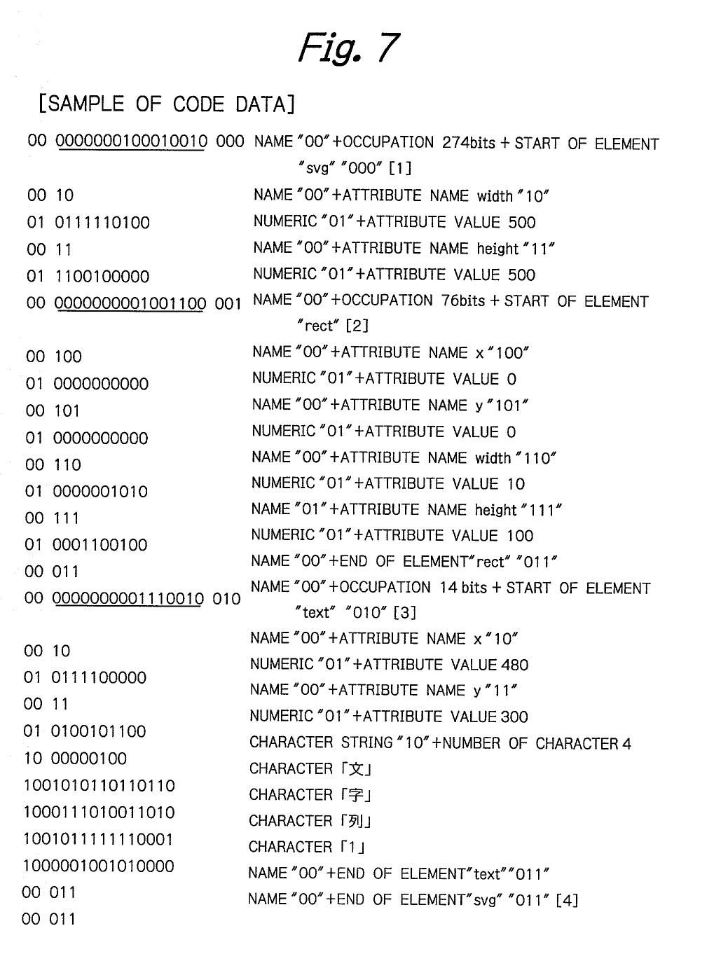

FIG. 7 illustrates a code data additionally including an occupancy data that indicates a length occupied by each element. By adding the occupancy length data into the code data, the client can execute document processing from the code data skipped over the occupancy data length when the code data contains a code that is not defined in the translation table.

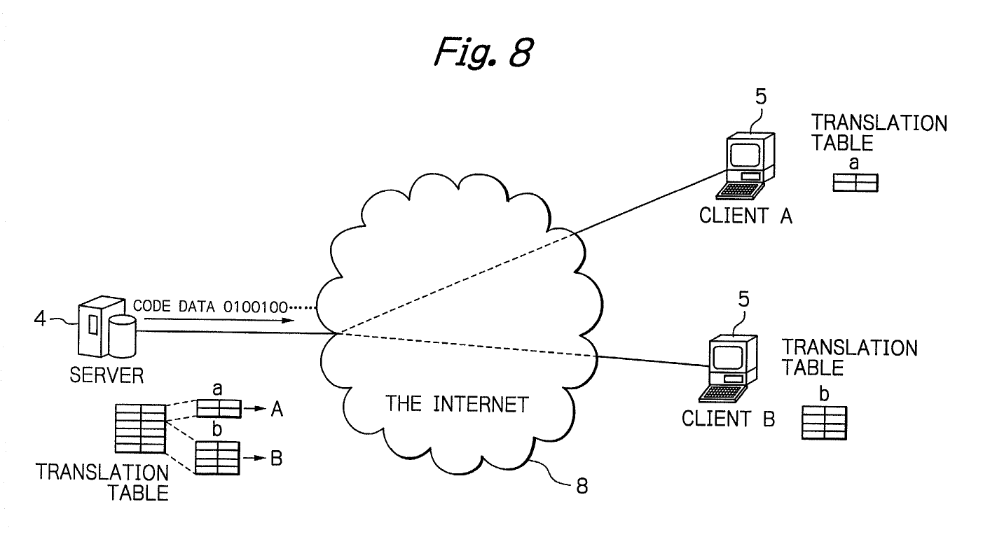

FIG. 8 illustrates a system configuration of a first embodiment according to the present invention. As shown in the figure, in this embodiment, a server 4 preliminarily sends translation tables a and b to clients A and B, respectively. The translation tables a and b sent are subsets of the items of the translation table owned by the server.

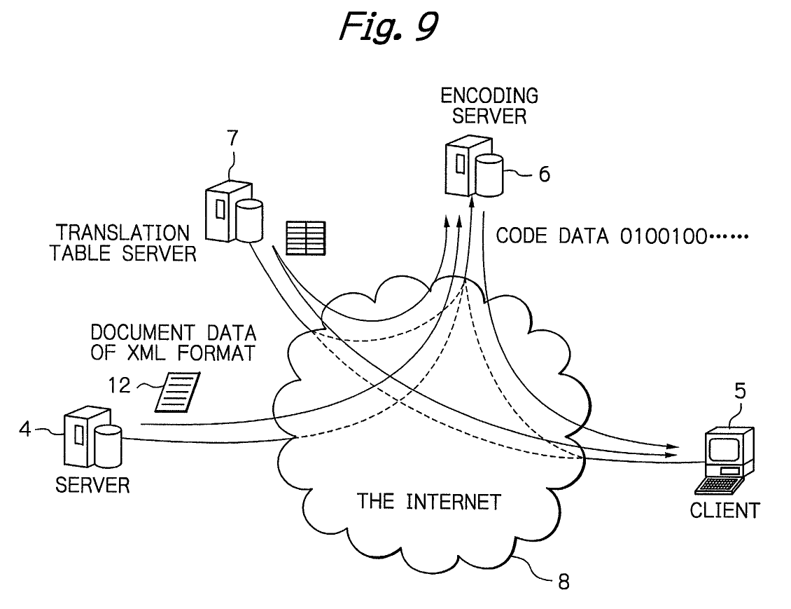

FIG. 9 illustrates a system configuration of a second embodiment according to the present invention, containing an encoding server 6. As shown in the figure, in this embodiment, a server 4 sends the document data of XML format to the encoding server 6. The encoding server 6 encodes the document data based on the translation table that received from a translation table server 7. The code data is sent to the client 5. The client 5 executes a document processing based on the translation table that received from the translation table server 7. According to this embodiment shown in FIG. 9, the encoding server 6 can be used as a proxy server, without adding alteration to the existing server that sends the document data of XML format.

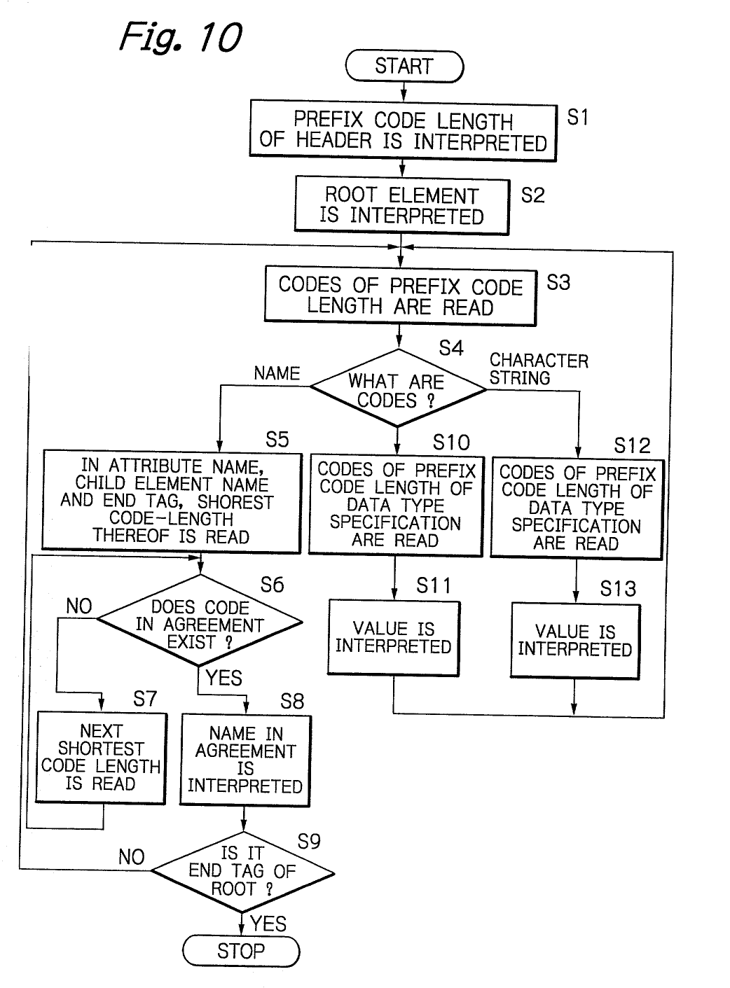

FIG. 10 illustrates a document processing according to the present invention. The document processing of the code data shown in of FIG. 4 based upon the translation table shown in FIG. 5, for example, will be described hereinafter.

(S1) Since it is noted from the translation table <head><prefix bit=“2”> that a header code length is two bits, two bits are read from the code data. From FIG. 4, it is revealed that a code of the two bits is “00”, and therefore the code is defined as “name”.

(S2) Next, it is noted from the translation table <head> <root name=“svg” bit=“3” code=“000”/> that a root element is “svg” and the following three bits are read from the code data. Since a code of the three bits is “000”, it is interpreted that the code is a start of an element “svg”.

(S3) Then, two bits of the header code length are read from the code data.

(S4) From FIG. 4, it is noted that a code of the two bits is “00”. Thus, it is interpreted that the code defines “name” based on the translation table <head>.

(S5) In a code length of an attribute name <attlist bit=2>, a code length of a child element name <children bit=3> and a code length of an end tag <end name=“/svg” bit=3 code=“011”/>, the code length to be read is two bits or three bits. Thus, at first, only two bits of the shortest code-length parts are read from the code data.

(S6) Since it is revealed that a code of the two bits is “10” from FIG. 4, then it is confirmed that the code “10” matches to an attribute name “width”.

(S7) If no code matches, at second, three bits of next shortest code length are read form the code data, and then the process returns S6 again.

(S8) It is interpreted that the code “10” is an attribute name “width”.

(S9) Then, it is confirmed that the following three bits are not an end tag <end name=“/svg” bit=3 code=“011”/>. If it is the end tag, the process will be terminated. If it is not the end tag, the process returns S3 again.

(S3) Two bits of the header code length are read from the code data.

(S4) From FIG. 4, it is revealed that a code of the two bits is “01”. Then, it is interpreted that “01” defines a “numeric” based upon the translation table <head>.

(S10) It is noted from the translation table <number bit=“10” data=“UI” qt=“1”/> that an attribute value of the attribute name “width” is ten bits of unsigned integer. Thus, ten bits are read from the code data.

(S11) Since the code of the ten bits is “0111110100”, it is interpreted that “0111110100” is an attribute value “500”. Then, the process returns to S3 again.

As mentioned above, by repeating the processes shown in FIG. 10, it is possible to perform code processing directly, without decoding the code data.

As explained in detail, according to the present invention, encoding of the document data indicated by the description language of an extensible text format can be executed. Since such encoding can reduce the amount of data to be transmitted, it is effective in a communication system with a low transmission rate, for example, in a radio communication.

Furthermore, according to the present invention, it is enabled to perform suitable encoding of the document data described in the extensible text format only by replacing the translation table without modifying a coding unit. Also, even when the document data are extended, it is possible to perform suitable encoding of the extended document data only by preparing an additional coding table for the extended part without modifying the coding table for the original document data.

Moreover, according to the present invention, by providing a special processing engine for document in a decode side client, reconstruction of the original document data from the received code data becomes unnecessary resulting to reduce a processing load at the decoding side client.

Many widely different embodiments of the present invention may be constructed without departing from the spirit and scope of the present invention. It should be understood that the present invention is not limited to the specific embodiments described in the specification, except as defined in the appended claims.

What is claimed is:

1. A method for code processing of document data comprising the steps of:
encoding a document data written in a description language of an extensible text format to a code data, based on a translation table written in a description language of an extensible text format; and
processing said code data as said document data based on said translation table,
said translation table defining link information of other translation tables, defining a code length and a code assigned to items of said link information, an element name, an element value of said element name, an attribute name designated in said element name, an attribute value of said attribute name, and defining a code length and a code assigned for designate parentage structure between one element name and other element name.

2. A method as claimed in claim 1, wherein said items defined in said translation table used in said processing step are a subset of said items defined in said translation table used in said encoding step.

3. A method as claimed in claim 1, wherein said encoding step encodes only the items that are defined in said translation table.

4. A method as claimed in claim 1, wherein said encoding step includes adding of an occupancy data which indicates a length occupied by said item to a code indicating said item, and wherein said processing step decodes from said code data of a position that skips said occupancy data length of said code, in case that said code not defined in said translation table exists in said code data, without processing said code.

5. A system for code processing of a document data comprising:
server for sending a document data written in a description language of an extensible text format;
encoding server for encoding said received document data to a code data based on a translation table, and sending the code data; and
client for processing of said code data as said document data based on said translation table,
said translation table being written in a description language of an extensible text format, defining a link information of other translation tables, defining a code length and a code assigned to items of said link information, an element name, an element value of said element name, an attribute name designated in said element name, an attribute value of said attribute name, and defining a code length and a code assigned to designate parentage structure between one element name and other element name.

6. A system as claimed in claim 5, wherein said items defined in said translation table used by said client are a subset of said items defined in said translation table used in said encoding server.

7. A system as claimed in claim 5, wherein said encoding server encodes only said items defined in said translation table.

8. A system as claimed in claim 5, wherein said encoding server adds an occupancy data which indicates a length occupied by said item to a code indicating said item, and wherein said client decodes from said code data of a position that skips said occupancy data length, in case that said code not defined in said translation table exists in said code data.
